(19) United States
(12) Patent Application Publication
(10) Pub. No.: US 2024/0324635 A1
(43) Pub. Date: Oct. 3, 2024

(54) SHELF-STABLE MULTI-USE INSTANT COOKING KIT WITH IMPROVED COOKABILITY AND INSTANT COOKED FOOD SUPPLY SYSTEM USING THE SAME

(71) Applicant: Eat the company Inc., Seoul (KR)

(72) Inventor: Bong Geun KIM, Seoul (KR)

(21) Appl. No.: 18/199,557

(22) Filed: Jun. 7, 2023

(30) Foreign Application Priority Data
Apr. 3, 2023 (KR) 10-2023-0043425

(51) Int. Cl. A23L 7/196; A23L 27/00; A23L 35/00; A47J 27/00; A47J 36/04

(52) U.S. Cl. CPC A23L 7/196; A23L 27/00; A23L 35/00; A47J 27/00; A47J 36/04

(57) ABSTRACT

According to one embodiment of the present invention, a shelf-stable multi-use instant cooking kit with improved cookability includes: an ingredient pack in which an uncooked dry ingredient is vacuum-packed; a seasoning pack in which a seasoning is vacuum-packed; a raw rice can in which raw rice is vacuum-stored in a container having a can shape so as to be shelf-stable; and a container including an inner layer having a rice cooker shape, and an outer layer surrounding the inner layer and having a handle, in which the dry ingredient, the seasoning, and the raw rice are inserted together into the container, and a preset amount of water is poured into the container, so that a cuisine in a form of a bowl of rice served with toppings is prepared when the dry ingredient, the seasoning, the raw rice, and the water are inserted and heated.

### BACKGROUND OF THE INVENTION

### 1. Field of the Invention

The present invention relates to a meal kit device capable of preparing a convenience food by using a modularized ingredient supply and cooking utensil and a technology for providing a convenience food to users by using the same, and more particularly, to a cooking kit capable of allowing users who are unable to ingest and prepare various foods due to childcare and lifestyles to replenish energy necessary for life and facilitate ingestion of essential nutrients, eliminating any inconvenience in cooking, and facilitating ingestion of various fresh cuisines.

### 2. Description of the Related Art

An HMR, an instant lunch box, and the like are shipped in a cooked state, so that convenience is provided for a cooking process, whereas reliability of ingredients and components is low. In particular, recently, accidents in which a bug is found in convenience store Gimbap (cooked rice rolled in dried layer) often occur, so that users recognize a lunch box sold at a convenience store as a very low-price and low-quality food. Accordingly, the lunch box is used only by users who are very busy.

In particular, breast-feeding mothers and postpartum users raising infants who are very few months old have a great need to supply essential nutrients and ingest fresh and safe foods for health of the users and children. However, since most of the users are raising children while holding the children in their arms, it is impossible to prepare a fresh food by the users themselves, so that the users have no choice but to get help from a postpartum helper or the like.

Therefore, the users have no choice but to feel a very heavy burden in eating a convenience store lunch or the like, while there is a situation in which the users have to ingest such a convenience food, so that there is an increasing need for technologies and products that provide fresh and safe foods to the users and allow the users to conveniently ingest a meal by using the fresh and safe foods.

In order to solve the above problems, Korean Patent Application No. 10-2019-0163790 or the like discloses a technology for cooking a fresh and nutritious convenience food by a simple cooking scheme of providing a major ingredient, a minor ingredient, a seasoning, and raw rice in packs, inserting the major ingredient, the minor ingredient, the seasoning, and the raw rice into a container, pouring water into the container, and heating the container.

The above technology has advantages that a nutritious single-meal cuisine is provided very simply, and various cuisines are prepared with a combination of various ingredients. However, the above technology has problems that storage at a room temperature may not be possible depending on an ingredient, and in particular, it is difficult to transport the container after cooking due to the nature of heat cooking when the container is hot.

In addition, upon purchase of the ingredients, it is not easy for users who are not familiar with cooking to predict a cuisine to be ingested when combining the ingredients, and there is a limitation in that a flavor derived by a combination of the ingredients may not be recognized.

### SUMMARY OF THE INVENTION

To solve the problems described above, particularly, one object of the present invention is to provide a technology related to a convenience food cooking kit in which ingredients are provided so as to be shelf-stable, cooking may be performed multiple times, and transport after heating is facilitated, so that functionality is significantly improved.

In addition, another object of the present invention is to provide a technology capable of allowing users who are not familiar with cooking to predict a flavor, a shape, and the like of a cuisine according to a combination of the ingredients in purchasing the ingredients and the like based on the cooking kit, and to select ingredients in consideration of a health condition and the like of the user.

To achieve the objects described above, according to one embodiment of the present invention, there is provided a shelf-stable multi-use instant cooking kit with improved cookability, the shelf-stable multi-use instant cooking kit including: an ingredient pack in which an uncooked dry ingredient that has been washed, dried, and cut is vacuum-packed so that the dry ingredient is shelf-stable and ingested when heated; a seasoning pack in which a seasoning for adding a flavor to the dry ingredient of the ingredient pack is vacuum-packed; a raw rice can in which raw rice dried so as to be cooked rice when heated for a same amount of time as the dry ingredient of the ingredient pack and the seasoning of the seasoning pack is vacuum-stored in a container having a can shape so as to be shelf-stable; and a container including an inner layer having a rice cooker shape, and an outer layer surrounding the inner layer and having a handle, in which the dry ingredient, the seasoning, and the raw rice are inserted together into the container, and a preset amount of water is poured into the container, so that a cuisine in a form of a bowl of rice served with toppings is prepared when the dry ingredient, the seasoning, the raw rice, and the water are inserted and heated.

The container may be configured such that: the inner layer is formed of polypropylene so as to be washable and usable multiple times, the inner layer is provided with a hanging wire having both ends coupled to arbitrary both points of an upper portion of the inner layer through hinge coupling so as to be rotatable, and the outer layer and the inner layer are separable from each other; and the outer layer has a heat-insulating property, and a protruding handle is formed on a side surface of the outer layer.

The dry ingredient and the raw rice may be treated and packed so as to be inserted together into the inner layer, washed, and heated.

The inner layer may include a plurality of first scales formed according to an amount of the water to be supplied depending on a texture of the raw rice after the dry ingredient and the raw rice are inserted.

For a case in which the dry ingredient and the raw rice are inserted while being stacked in the form of the bowl of rice served with the toppings, the inner layer may be configured such that a second scale for measuring an amount of the raw rice determined according to a recipe, a third scale for measuring the dry ingredient, and the first scales are sequentially formed on a side wall of the inner layer in a height direction.

A plurality of first scales formed according to an amount, which is obtained by dividing an amount of the water to be supplied depending on a texture of the raw rice after the dry ingredient and the raw rice are inserted by a natural number, may be marked on an outer side of the raw rice can, so that the amount of the water to be supplied is reached by inserting the raw rice of the raw rice can into the inner layer, inserting the water into the raw rice can up to the first scale, and pouring the water into the inner layer a plurality of times.

Meanwhile, according to one embodiment of the present invention, there is provided an instant cooked food supply system using a shelf-stable multi-use instant cooking kit, the instant cooked food supply system including: an interface provision unit for providing a purchase interface, which is for purchasing a container, an ingredient pack, a seasoning pack, and a raw rice can of the multi-use instant cooking kit independently or in a set, to a user terminal; a cuisine result prediction information provision unit for providing information on a cuisine prepared when cooking is performed through the multi-use instant cooking kit to the purchase interface according to information on the ingredient pack, the seasoning pack, and the raw rice can selected from a user account; and an ingredient selection guide unit for guiding selection of the ingredient pack, the seasoning pack, and a type of raw rice according to disease and health characteristics of a user, which are information stored in the user account.

The cuisine result prediction information provision unit may provide prediction image data of the cuisine and qualitative data representing detailed attribute information of the cuisine to the purchase interface.

The detailed attribute information of the cuisine may include at least one of flavor data including a bitter flavor, a sweet flavor, a salty flavor, a savory flavor, and a viscosity of the cuisine, nutrient data including information on calories and detailed nutrients included in the cuisine, and target data including disease and health condition information of another user account that has purchased an ingredient pack, a seasoning pack, and raw rice included in a same cuisine.

The flavor data may be output to the purchase interface in a form of a radar chart derived as a result of digitizing each of the flavors and the viscosity constituting the flavor data based on evaluation information of the another user account on the same cuisine.

According to the present invention, a container including an inner layer formed of a polypropylene (PP) material so as to heatable and usable multiple times through washing and an outer layer formed of a heat-insulating material and surrounding the inner layer may be provided together with a major ingredient and raw rice, which are dried and vacuum-packed so as to be shelf-stable, and a seasoning. In this case, users can prepare a cuisine having very high quality by inserting the major ingredient and the raw rice into the container very conveniently according to scales marked on the container after washing the major ingredient and the raw rice, pouring water into the container, and heating the container.

Accordingly, ingredients may be provided so as to be shelf-stable, cooking may be performed multiple times, and transport after heating may be facilitated, so that functionality can be significantly improved.

In addition, users may recognize a cuisine predicted when purchasing ingredients through a purchase interface by using an image, detailed flavor data, and the like, so that even users who are not familiar with cooking can predict a flavor, a shape, and the like of the cuisine according to a combination of the ingredients in purchasing the ingredients, and can select ingredients in consideration of a health condition and the like of the user.

### BRIEF DESCRIPTION OF THE DRAWINGS

FIG. 1 is a view showing a configuration of a shelf-stable multi-use instant cooking kit with improved cookability according to one embodiment of the present invention.

FIG. 2 is a view showing a structure of a container according to one embodiment of the present invention.

FIG. 3 is a view for describing a structure of scales formed on an inner layer of the container according to one embodiment of the present invention.

FIG. 4 is a view for describing a structure of a scale formed on a raw rice can according to one embodiment of the present invention.

FIG. 5 is a view for describing a structure of an instant cooked food supply system using a shelf-stable multi-use instant cooking kit according to one embodiment of the present invention.

FIGS. 6 and 7 are views showing examples of screens of a purchase interface implemented according to one embodiment of the present invention.

### DETAILED DESCRIPTION OF THE INVENTION

Hereinafter, various embodiments and/or aspects will be disclosed with reference to the drawings. In the following description, for the purpose of description, numerous specific details are set in order forth to facilitate an overall understanding of one or more aspects. However, it will also be appreciated by a person having ordinary skill in the art to which the present invention pertains that such aspect (s) may be practiced without the specific details. The following description and the accompanying drawings will be set forth in detail for specific illustrative aspects among the one or more aspects. However, the aspects are provided for illustrative purposes, some of various schemes based on principles of various aspects may be employed, and descriptions set forth herein are intended to include all the aspects and equivalents thereof.

The terms “embodiment”, “example”, “aspect”, “illustration”, and the like used herein may not be construed as indicating that any aspect or design set forth herein is preferable or advantageous over other aspects or designs.

In addition, it is to be understood that the terms “include” and/or “comprise” indicate the presence of corresponding features and/or elements, but do not preclude the presence or addition of one or more other features, elements, and/or groups thereof.

In addition, although the terms including ordinal numbers such as “first” and “second” may be used to describe various elements, the elements are not limited by the terms. The above terms are used merely for the purpose of distinguishing one element from another element. For example, a first element may be termed as a second element, and similarly, a second element may also be termed as a first element without departing from the scope of the present invention. The term “and/or” includes any combination of a plurality of described relevant items, or one of the described relevant items.

In addition, unless defined otherwise, all terms used in embodiments of the present invention, including technical and scientific terms, have the same meaning as those commonly understood by a person having ordinary skill in the art to which the present invention pertains. Any terms as those defined in generally used dictionaries are to be interpreted to have the meanings consistent with the contextual meanings in the relevant field of art, and are not to be interpreted to have idealistic or excessively formalistic meanings unless explicitly defined in the embodiments of the present invention.

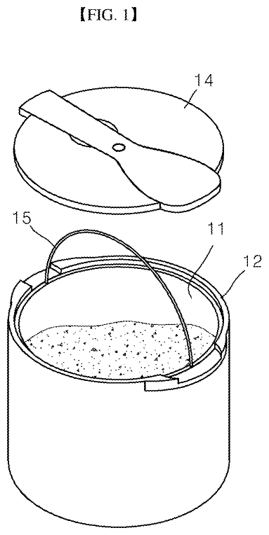

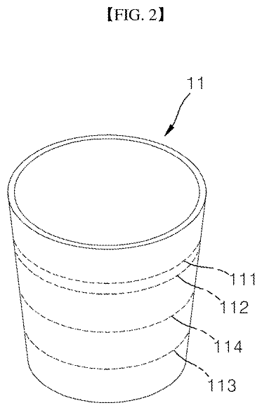

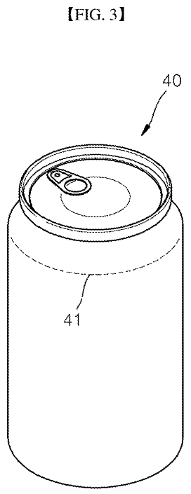

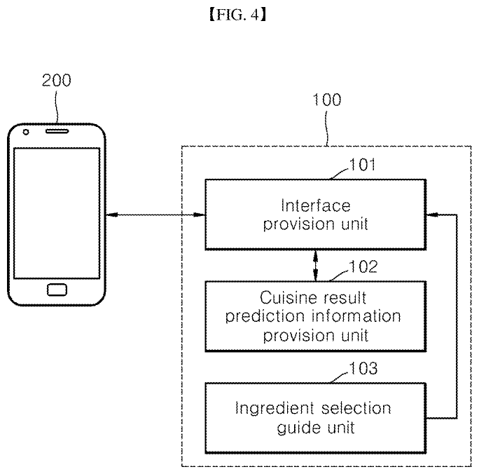

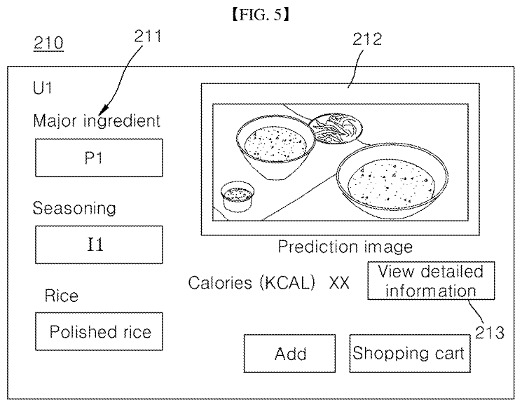

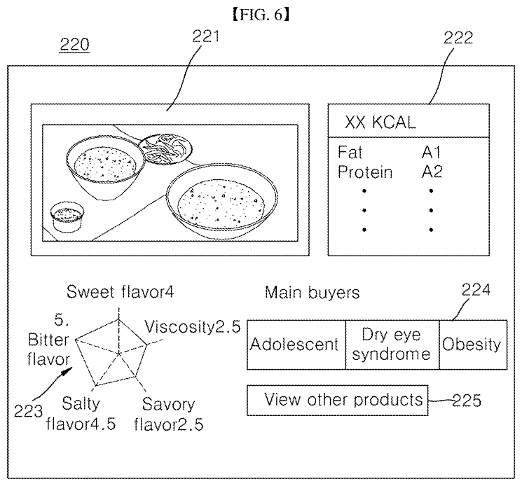

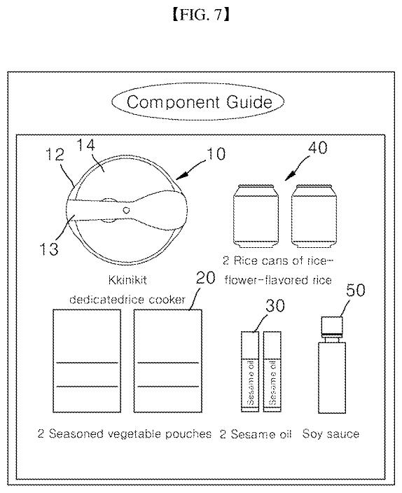

FIG. 1 is a view showing a configuration of a shelf-stable multi-use instant cooking kit with improved cookability according to one embodiment of the present invention, FIG. 2 is a view showing a structure of a container according to one embodiment of the present invention, FIG. 3 is a view for describing a structure of scales formed on an inner layer of the container according to one embodiment of the present invention, FIG. 4 is a view for describing a structure of a scale formed on a raw rice can according to one embodiment of the present invention, FIG. 5 is a view for describing a structure of an instant cooked food supply system using a shelf-stable multi-use instant cooking kit according to one embodiment of the present invention, and FIGS. 6 and 7 are views showing examples of screens of a purchase interface implemented according to one embodiment of present invention.

Meanwhile, in the following description, although some components shown in the drawings have been omitted or excessively enlarged or reduced in order to describe a function of each of the components of the present invention, it is to be understood that the details shown in the drawings do not limit the technical features and scope of the present invention.

In addition, in the following description, a plurality of drawings may be simultaneously referenced in order to describe one technical feature or one element constituting the invention.

Referring to the above drawings together, first, a shelf-stable multi-use instant cooking kit may include an ingredient pack 20, a seasoning pack 30, a rice can 40, and a container 10.

The ingredient pack 20 may be a component in which an uncooked dry ingredient that has been washed, dried, and cut is vacuum-packed so that the dry ingredient is shelf-stable and ingested when heated. In detail, for example, seasoned vegetables such as seasoned aster and seasoned canola, minor ingredients such as meat powder included in the seasoned vegetables, and the like may be mixed with each other in the ingredient pack 20, and may be washed and dried so as to be cooked when heated after pouring water. In addition, when there is an ingredient such as meat, the ingredient may be dried and provided after being partially or completely heated in advance so that cooking may be performed according to a heating time.

In addition, a size of the ingredient pack 20 may be minimized through vacuum compression packing when packing ingredients, and an outward shape of the ingredient pack 20 may be preferably configured such that the packing is performed by an opaque material so as to enable storage at a room temperature without an influence of a direct sunlight and the like, and a partial region is transparent so as to allow a partial ingredient to be identified during the packing.

The ingredients included in the ingredient pack 20 may include the seasoned vegetables as major ingredients as described above so that a healthy food may be ingested. Meanwhile, in addition to performing a function of each of the ingredients described above, as a main object of the present invention, the ingredients may be configured such that nutrients are regularly distributed for users who may not eat a meal with regular nutrients, such as child-caring mothers.

For example, according to the present invention, the ingredients included in the ingredient pack 20 may include one food ingredient among meat, vegetables, beans, seaweeds, fishes, and shellfishes including one of nutrients of protein, fat, calcium, and fiber components among five major nutrients, which are nutrients that may be mainly included in the above example. In this case, a size, a state, a shape, and the like of the meat, the vegetables, the beans, the seaweeds, the fishes, and the shellfishes may be processed as described above. For example, skin, intestines, and the like of a fish may be dressed so that the fish may be directly heated in a microwave oven or the like and ingested, and shellfishes and the like may be in a washed state.

Other ingredients that may be included in the ingredient pack 20 may also include, for example, one food ingredient among meat, vegetables, beans, seaweeds, fruits, fishes, and shellfishes at least including one of nutrients of mineral, fiber, and vitamin components, which are five major nutrients required in relatively small amounts. In this case, a size, a state, a shape, and the like of the meat, the vegetables, the beans, the seaweeds, the fishes, and the shellfishes may be processed as described above so that the meat, the vegetables, the beans, the seaweeds, the fishes, and the shellfishes may be immediately ingested when heated in a microwave oven.

Meanwhile, the technical feature of the present invention is that a cooking utensil and the like except for the microwave oven are not used at all in addition to basic ingredients such as water, while a meal may be provided to the user. To this end, according to the present invention, each of the ingredients may be adjusted in a recommended amount according to a condition of the user.

In other words, according to the present invention, an amount of each food ingredient may be determined according to a recommended intake of a breast-feeding mother or a postpartum child-caring mother, who is a main user of the present invention, per a preset period (e.g., 1 week or 1 day). The main user of the present invention, such as a breast-feeding mother, may naturally have a problem upon a low intake of nutrients, and may have a big problem in diseases such as diabetes upon an excessive intake of specific groceries. Accordingly, the amount of each food ingredient may be determined and provided as described above.

For example, while fish ingestion during pregnancy and breast-feeding has a risk of mercury contamination, a fish is a rich supply source of protein, vitamin B, zinc, iodine, and selenium as well as long-chain omega-3 fatty acids and vitamin D, and a fish is known to affect vision, cognition, motor, and behavior developments of a baby. Accordingly, the Food and Drug Administration (FDA) recommends ingestion of 12 ounces, that is, 340 grams, of a small fish per week during the breast-feeding.

In addition, accumulation of body fat during the pregnancy and reduction of the body fat during the breast-feeding may cause a change in a size of fat cells, not a number of fat cells, and calories in breast milk of a well-nourished breast-feeding mother may be about 75 kcal/dL. Breast milk of an undernourished woman with an extremely low fat storage amount may have fewer calories.

According to one research, the breast-feeding mother may consume more calories of 580 kcal per day than an ordinary woman (2460 kcal:1880 kcal). While metabolic efficiency of a woman increases significantly during the breast-feeding, factors other than the breast-feeding in calorie use of a mother body may be decreased. A recommended calorie intake per day during the breast-feeding may be about 2700 kcal, and some nutrients may be lacking upon a calorie intake (2200 kcal) of a general and actual breast-feeding mother. Calcium, zinc, magnesium, thiamine, vitamin B6, vitamin E, riboflavin, folic acids, phosphorus, and iron may be lacking unless special attention is paid to each nutrient upon a minimum calorie intake (1800 kcal) of the breast-feeding mother.

The breast-feeding mothers are advised to sufficiently ingest fruits, vegetables, whole grains, calcium-rich dairy products, and protein-rich foods. Vitamin or mineral supplements may not be necessary for the breast-feeding mothers. However, a state of satisfying specific nutrients may be carefully reviewed, and when the specific nutrients are deficient, a food that is rich in the nutrients has to be ingested.

In addition to the breast-feeding mothers, there may be nutrients that may be lacking other than the above nutrients depending on various lifestyles. According to various embodiments of the present invention, an ingredient pack 20 recommended for each ingesting user may be recommend upon selling based on the lacking nutrients, so that the ingesting users may conveniently receive nutrients that are lacking in the ingesting users. A detailed description thereof will be described below.

Based on the above consideration factors, an amount of the major ingredient or raw rice, which will be described below, may be determined, and an amount of the minor ingredient and a seasoning may be determined according to the amount of the major ingredient or the raw rice. As a result, nutrients customized to users, especially the breast-feeding mothers who perform the breast-feeding and the like, may be sufficiently provided, and an excellent flavor may be implemented, so that a meal such as a bowl of rice served with toppings may be provided to the users to allow the users to have the meal without a separate cooking utensil when the users are busy.

As shown in FIG. 1, seasoning packs 30 and 50 may refer to a kind of a seasoning pack group including seasonings for flavoring a cuisine of a bowl of rice served with toppings, such as sesame oil and soy sauce. In this case, a first seasoning pack 30 may be a pack or a container for storing ingredients such as oil and a spice, which are prepared according to an amount of seasoning to be inserted once for each cuisine, and a second seasoning pack 50 may be a pack or a container for storing seasonings such as soy sauce, which may be commonly included for each cuisine so as to be included in the kit and sold so as to be inserted multiple times, in which an amount of the second seasoning pack 50 may be set and provided so as to be inserted multiple times.

According to the present invention, the container 10, the ingredient pack 20, the seasoning packs 30 and 50, and the raw rice can 40 may be, for example, sold as a cooking kit product as shown in FIG. 1 when purchased once, the container 10 may be reused, and the second seasoning pack 50 may also be used multiple times depending on the amount of the second seasoning pack 50, so that the users may access a system that will be described below to separately purchase and use the ingredient pack 20, the first seasoning pack 30, and the raw rice can 40 independently of each other or in a set. Accordingly, the container 10 and the second seasoning pack 50 may be provided so as to be used multiple times as described above, so that The amount of the second seasoning pack 50 may be variously configured while enabling the use for multiple times.

In addition, the second seasoning pack 50 or the first seasoning pack 30 may include various ingredients such as red chili-pepper paste with vinegar, red pepper paste, soybean paste, Ssamjang (a mixture of the soybean paste and the red pepper paste), perilla oil, and olive oil in addition to the oil and the soy sauce described above.

Meanwhile, the raw rice can 40 may refer to a component in which raw rice dried so as to be cooked rice when heated for a same amount of time as the dry ingredient of the ingredient pack and the seasoning of the seasoning pack is vacuum-stored in a container having a can shape so as to be shelf-stable. A size of the container of the raw rice can 40 and an amount of the raw rice included in the raw rice can 40 may be variously configured so as to vary according to the users.

For example, when the raw rice can is configured as various products such as a raw rice can for a pregnant women, a raw rice can for an examinee, a raw rice can for a diabetic patient, types and amounts of raw rice included in the products may be different from each other. In this case, when accessing the system for purchasing or repeatedly purchasing a new cooking kit as shown in FIG. 1, the system may sell various ingredients, seasonings, and raw rice so that the users may select and purchase various raw rice cans 40 in addition to the ingredient pack 20 and the seasoning packs 30 and 50 as described above.

Accordingly, even when the user owns only the container 10, a wide variety of cuisines of a bowl of rice served with toppings may be prepared and ingested in almost the same simple way through purchase of various ingredient packs 20, seasoning packs 30 and 50, and raw ingredient cans 40.

Meanwhile, the ingredients and the raw rice stored in the ingredient pack 20 and the raw rice can 40, respectively, may be shelf-stable as described above. To this end, the raw rice can 40 may also be configured such that the raw rice becomes the cooked rice when washed and heated after pouring the water, is supplied in a washed and dried state so as to be shelf-stable, and is vacuum-packed by the raw rice can 40 so as to be provided.

In this case, the dry ingredient included in the ingredient pack 20 and the raw rice included in the raw rice can 40 may be treated and packed so as to be inserted into an inner layer 11 of the container, which will be described below, washed, and heated.

As shown in FIGS. 1 and 2, the container 10 may refer to a component including an inner layer 11 having a rice cooker shape, and an outer layer 12 surrounding the inner layer 11 and having a handle, in which the dry ingredient, the seasoning, and the raw rice are inserted together into the container 10, and a preset amount of water is poured into the container 10, so that a cuisine in a form of a bowl of rice served with toppings is prepared when the dry ingredient, the seasoning, the raw rice, and the water are inserted and heated.

The container 10 may additionally include a cover 14 as shown in FIG. 2 in order to restrict external transfer of the ingredients during heating and effectively cook the raw rice during the heating by applying a constant pressure. For example, the cover 14 may be formed of the same material as the inner layer 11 so as to be fitted and coupled into a concave guide line on an inner surface of the outer layer 12 formed of an elastic material to obtain the same effect as a rice cooker.

At the same time, as shown in FIGS. 1 and 2, the cover 14 may be formed on an outer surface thereof with a plurality of through-holes. For example, the cover 14 may be configured such that a diameter of a bottom surface, that is, a region making contact with the inner layer 11, is smaller than a diameter of a top surface, that is, a region making contact with an outside, and the through-hole has a diameter that allows a middle region of the through-hole, that is, a region between the bottom surface and the top surface, to be the smallest, so that the same effect as a pressure rice cooker may be obtained, thereby greatly increasing efficiency of the cooking.

Meanwhile, a spatula 13 may be provided as shown in FIG. 1 to move the cuisine of the bowl of rice served with toppings cooked from the container to a bowl or evenly mix the ingredients and the raw rice. When the spatula 13 is provided, in order to enable a smooth movement and the like of the spatula 13, the spatula 13 may be provided so as to be fixable to the cover 14. In this case, as shown in FIG. 1, a through-hole may be formed in a central portion of the spatula 13, and the cover 14 may include a groove having a shape similar to an outer shape of the spatula 13, and a protrusion formed in a region corresponding to a region in which the through-hole of the spatula 13 is formed, so that the spatula 13 may be coupled to the cover 14 by fitting the spatula 13 along the protrusion and the groove.

Meanwhile, the inner layer 11 may be formed of a polypropylene (PP) material so as to be washable so that the inner layer 11 may be separated from the outer layer 12 so as to be washable and usable multiple times. In this case, the cover 14 may also be formed of the PP material as described above. Accordingly, the same effect as the rice cooker may be obtained, and the use for multiple times may be enabled.

Meanwhile, in order to facilitate separation of the inner layer 11 and the outer layer 12 from each other, prevent burns when directly gripping the inner layer 11, and enable convenient transfer of the inner layer 11, as shown in FIG. 2, the inner layer 11 may be provided with a hanging wire 15 having both ends coupled to arbitrary both points of an upper portion of the inner layer 11 through hinge coupling so as to be rotatable, and the outer layer 12 and the inner layer 11 may be separable from each other; and the outer layer 12 may have a heat-insulating property, and a protruding handle may be formed on a side surface of the outer layer 12 as shown in FIG. 2 and the like.

Meanwhile, for very convenient cooking, a function including convenience may be provided so that the users may perform cooking without reading a manual. In this case, a cuisine cooked according to each embodiment of the present invention may be prepared by inserting the dry ingredient of the ingredient pack 20 and the raw rice of the raw rice can 40 into the inner layer 11, washing the dry ingredient and the raw rice, pouring the seasoning pack and the water, and performing cooking in a microwave oven or the like for about 18 minutes as described above.

In this case, when a height of the water inserted or the like is configured by one of the above components, the users may cook a cuisine as a meal that is delicious and allows ingestion of nutrients necessary for each user as described above by conveniently inserting all the ingredients and pouring the water according to a determined amount without manually reading a cooking manual.

To this end, according to a first embodiment of the present invention, as shown in FIG. 3, the inner layer 11 of the container 10 may include a plurality of first scales 111 and 112 formed according to an amount of the water to be supplied depending on a texture of the raw rice after the dry ingredient and the raw rice are inserted. In this case, the texture of the raw rice may refer to a texture of the cooked rice prepared by the raw rice after the cooking, in which a small amount of the water that relatively allows to feel the texture of the raw rice and a large amount of the water that allows to feel a soft texture may be set and determined in advance according to amounts of the dry ingredient and the raw rice in the ingredient pack 20 and the raw rice can 40 provided one time. In addition, the first scales 111 and 112 may be determined according to the determined amount of the water and a size of the inner layer 11 of the container.

Meanwhile, a user among the users may use only the container 10 or the ingredient pack 20, and perform the cooking by separately purchasing the dry ingredient or the raw rice from other stores. Even in this case, when the amounts of the ingredient and the raw rice are approximately guided, even users who are unskilled with the cooking may prepare a cuisine by using only the container 10 in a relatively simple scheme.

To this end, according to a second embodiment of the present invention, for a case in which the dry ingredient and the raw rice are inserted while being stacked in the form of the bowl of rice served with the toppings, a second scale 113 for measuring an amount of the raw rice determined according to a recipe and a third scale 114 for measuring the dry ingredient may be provided in addition to the first scales 111 and 112 according to the first embodiment, and the second scale 113, the third scale 114, and the first scales 112 and 111 may be sequentially formed (marked) on a side wall of the inner layer 11 in a height direction from a bottom of the inner layer 11.

Meanwhile, in a case where a line as described above is marked on the inner layer 11, when the line is marked as an embossment or intaglio that is concave or convex, a detergent may remain in a fine bent region around the embossment or in a groove of the intaglio during washing, which may be harmful to health, and when the line is marked with paint or the like, the scale may be removed during multiple washing, which may cause inconvenience in cooking.

In this case, when the scale is marked on a container-type component that is relatively for one-time use, side effects as described above may be completely eliminated. To this end, according to a third embodiment of the present invention, as shown in FIG. 4, a plurality of first scales 41 according to an amount, which is obtained by dividing an amount of the water to be supplied depending on a texture of the raw rice after the dry ingredient and the raw rice are inserted by a natural number, may be marked on an outer side of the raw rice can 40, so that the amount of the water to be supplied may be reached by inserting the raw rice of the raw rice can 40 into the inner layer 11, inserting the water into the raw rice can 40 up to the first scale 41, and pouring the water into the inner layer 11 a plurality of times.

In this case, a fixed amount of the water may be provided by receiving the water in the raw rice can 40, measuring the water, and pouring the water into the inner layer 11 without the need to mark the scale on the container. In this case, in addition to the side effects caused by the formation of the scale of the inner layer 11 described above, an additional effect of supplying the raw rice remaining in the raw rice can 40 while washing the raw rice down to the inner layer 11 by pouring the water may also be expected.

Meanwhile, as described above, each of the components and the cooking kit as shown in the drawings mentioned in the description of FIGS. 1 to 4 may be purchased through a purchase interface outputted by access of the user on an instant cooked food supply system 100 (hereinafter referred to as “system according to the present invention”) using a shelf-stable multi-use instant cooking kit as shown in FIGS. 5 to 7 that will be described below.

As shown in FIG. 5, the system 100 according to the present invention may include an interface provision unit 101, a cuisine result prediction information provision unit 102, and an ingredient selection guide unit 103.

The interface provision unit 101 may perform a function of providing a purchase interface, which is for purchasing a container 10, an ingredient pack 20, seasoning packs 30 and 50, and a raw rice can 40 of the multi-use instant cooking kit independently or in a set, to a user terminal 200.

Meanwhile, the cuisine result prediction information provision unit 102 may perform a function of providing information on a cuisine prepared when cooking is performed through the multi-use instant cooking kit to the purchase interface according to information on the ingredient pack, the seasoning pack, and the raw rice can selected from a user account.

Examples of the above configuration are shown in FIGS. 6 and 7. FIGS. 6 and 7 are views showing examples of screens output to the user terminal 200 according to the functions described above, in which examples of output screens according to implementation of sub-interfaces included in the purchase interface are described.

First, referring to a screen 210 of FIG. 6, the cuisine result prediction information provision unit 102 may provide prediction image data 212 of the cuisine and qualitative data representing detailed attribute information of the cuisine among the information on the cuisine prepared when the cooking is performed through the screen 210 included in the purchase interface.

The users may select ingredients on the screen 210 through an ingredient selection menu 211 for selecting ingredients (P1, I1, polished rice) and the like as shown in FIG. 6. In this case, when the ingredients are selected, the prediction image data 212 may be output in real time. The prediction image data 212 may be data input by an operating entity of the system 100 through photographing a sample of a cuisine derived when the cooking is performed by combining the ingredients in advance.

Meanwhile, the detailed attribute information of the cuisine among the above information may be output through a view-detailed-information menu 213. An example of a screen output through the view-detailed-information menu 213 is shown as a screen 220 of FIG. 7.

Referring to the screen 220, flavor data 223, nutrient data 222, target data 224, and the like may be included in the detailed attribute information of the cuisine so as to be output, and a view-other-products menu 225 may also be included. The view-other-products menu 225 may be, for example, a menu through which information on a combination of ingredients and the like purchased by other user accounts that have purchased a product similar to a user included in the target data 224 or popular among the other user accounts may be recognized.

As shown in FIG. 7, the flavor data 223 may be digitized data capable of predicting a flavor including a bitter flavor, a sweet flavor, a salty flavor, a savory flavor, and a viscosity of the cuisine. In this case, in order to enable intuitive recognition, the flavor data 223 may be output to the purchase interface in a form of a radar chart as shown in FIG. 7 derived as a result of digitizing each of the flavors and the viscosity constituting the flavor data based on evaluation information of other user accounts on the same cuisine.

The nutrient data 222 may include information on calories and detailed amounts of nutrients as shown in FIG. 7, and the target data 224 may be information including disease and health condition information of other user accounts that have purchased an ingredient pack, a seasoning pack, and raw rice included in the same cuisine. When the target data 224 is recognized, the users may determine diseases, constitutions, or ingestion purposes of users who mainly used the ingredients and the cuisine cooked from the ingredients, so that ingredients that suit a condition of the user may be wisely selected and purchased.

Although the above description has been made with reference to specific embodiments and drawings, it will be understood by those skilled in the art that various modifications and changes can be made from the above description. The term such as “include”, “comprise”, or “have” described above means that an element that is not explicitly described to the contrary may be inherent, so that the term is to be interpreted as being able to further include other elements but not excluding other elements. In addition, the scope of the present invention is to be defined by the appended claims, and construed as encompassing all technical ideas within the scope of equivalents thereof.

1. A shelf-stable multi-use instant cooking kit with improved cookability, the shelf-stable multi-use instant cooking kit comprising:
an ingredient pack in which an uncooked dry ingredient that has been washed, dried, and cut is vacuum-packed so that the dry ingredient is shelf-stable and ingested when heated;
a seasoning pack in which a seasoning for adding a flavor to the dry ingredient of the ingredient pack is vacuum-packed;
a raw rice can in which raw rice dried so as to be cooked rice when heated for a same amount of time as the dry ingredient of the ingredient pack and the seasoning of the seasoning pack is vacuum-stored in a container having a can shape so as to be shelf-stable; and
a container including an inner layer having a rice cooker shape, and an outer layer surrounding the inner layer and having a handle, in which the dry ingredient, the seasoning, and the raw rice are inserted together into the container, and a preset amount of water is poured into the container, so that a cuisine in a form of a bowl of rice served with toppings is prepared when the dry ingredient, the seasoning, the raw rice, and the water are inserted and heated.

2. The shelf-stable multi-use instant cooking kit of claim 1, wherein the container is configured such that:
the inner layer is formed of polypropylene so as to be washable and usable multiple times, the inner layer is provided with a hanging wire having both ends coupled to arbitrary both points of an upper portion of the inner layer through hinge coupling so as to be rotatable, and the outer layer and the inner layer are separable from each other; and
the outer layer has a heat-insulating property, and a protruding handle is formed on a side surface of the outer layer.

3. The shelf-stable multi-use instant cooking kit of claim 1, wherein the dry ingredient and the raw rice are treated and packed so as to be inserted together into the inner layer, washed, and heated.

4. The shelf-stable multi-use instant cooking kit of claim 1, wherein the inner layer includes a plurality of first scales formed according to an amount of the water to be supplied depending on a texture of the raw rice after the dry ingredient and the raw rice are inserted.

5. The shelf-stable multi-use instant cooking kit of claim 4, wherein, for a case in which the dry ingredient and the raw rice are inserted while being stacked in the form of the bowl of rice served with the toppings, the inner layer is configured such that a second scale for measuring an amount of the raw rice determined according to a recipe, a third scale for measuring the dry ingredient, and the first scales are sequentially formed on a side wall of the inner layer in a height direction.

6. The shelf-stable multi-use instant cooking kit of claim 1, wherein a plurality of first scales formed according to an amount, which is obtained by dividing an amount of the water to be supplied depending on a texture of the raw rice after the dry ingredient and the raw rice are inserted by a natural number, are marked on an outer side of the raw rice can, so that the amount of the water to be supplied is reached by inserting the raw rice of the raw rice can into the inner layer, inserting the water into the raw rice can up to the first scale, and pouring the water into the inner layer a plurality of times.

7. An instant cooked food supply system using a shelf-stable multi-use instant cooking kit according to claim 1, the instant cooked food supply system comprising:
an interface provision unit for providing a purchase interface, which is for purchasing a container, an ingredient pack, a seasoning pack, and a raw rice can of the multi-use instant cooking kit independently or in a set, to a user terminal;
a cuisine result prediction information provision unit for providing information on a cuisine prepared when cooking is performed through the multi-use instant cooking kit to the purchase interface according to information on the ingredient pack, the seasoning pack, and the raw rice can selected from a user account; and
an ingredient selection guide unit for guiding selection of the ingredient pack, the seasoning pack, and a type of raw rice according to disease and health characteristics of a user, which are information stored in the user account.

8. The instant cooked food supply system of claim 7, wherein the cuisine result prediction information provision unit provides prediction image data of the cuisine and qualitative data representing detailed attribute information of the cuisine to the purchase interface.

9. The instant cooked food supply system of claim 8, wherein the detailed attribute information of the cuisine includes at least one of flavor data including a bitter flavor, a sweet flavor, a salty flavor, a savory flavor, and a viscosity of the cuisine, nutrient data including information on calories and detailed nutrients included in the cuisine, and target data including disease and health condition information of another user account that has purchased an ingredient pack, a seasoning pack, and raw rice included in a same cuisine.

10. The instant cooked food supply system of claim 9, wherein the flavor data is output to the purchase interface in a form of a radar chart derived as a result of digitizing each of the flavors and the viscosity constituting the flavor data based on evaluation information of the another user account on the same cuisine.

11. An instant cooked food supply system using a shelf-stable multi-use instant cooking kit according to claim 2, the instant cooked food supply system comprising:
an interface provision unit for providing a purchase interface, which is for purchasing a container, an ingredient pack, a seasoning pack, and a raw rice can of the multi-use instant cooking kit independently or in a set, to a user terminal;
a cuisine result prediction information provision unit for providing information on a cuisine prepared when cooking is performed through the multi-use instant cooking kit to the purchase interface according to information on the ingredient pack, the seasoning pack, and the raw rice can selected from a user account; and
an ingredient selection guide unit for guiding selection of the ingredient pack, the seasoning pack, and a type of raw rice according to disease and health characteristics of a user, which are information stored in the user account.

12. An instant cooked food supply system using a shelf-stable multi-use instant cooking kit according to claim 3, the instant cooked food supply system comprising:
an interface provision unit for providing a purchase interface, which is for purchasing a container, an ingredient pack, a seasoning pack, and a raw rice can of the multi-use instant cooking kit independently or in a set, to a user terminal;
a cuisine result prediction information provision unit for providing information on a cuisine prepared when cooking is performed through the multi-use instant cooking kit to the purchase interface according to information on the ingredient pack, the seasoning pack, and the raw rice can selected from a user account; and
an ingredient selection guide unit for guiding selection of the ingredient pack, the seasoning pack, and a type of raw rice according to disease and health characteristics of a user, which are information stored in the user account.

13. An instant cooked food supply system using a shelf-stable multi-use instant cooking kit according to claim 4, the instant cooked food supply system comprising:
an interface provision unit for providing a purchase interface, which is for purchasing a container, an ingredient pack, a seasoning pack, and a raw rice can of the multi-use instant cooking kit independently or in a set, to a user terminal;
a cuisine result prediction information provision unit for providing information on a cuisine prepared when cooking is performed through the multi-use instant cooking kit to the purchase interface according to information on the ingredient pack, the seasoning pack, and the raw rice can selected from a user account; and
an ingredient selection guide unit for guiding selection of the ingredient pack, the seasoning pack, and a type of raw rice according to disease and health characteristics of a user, which are information stored in the user account.

14. An instant cooked food supply system using a shelf-stable multi-use instant cooking kit according to claim 5, the instant cooked food supply system comprising:
an interface provision unit for providing a purchase interface, which is for purchasing a container, an ingredient pack, a seasoning pack, and a raw rice can of the multi-use instant cooking kit independently or in a set, to a user terminal;
a cuisine result prediction information provision unit for providing information on a cuisine prepared when cooking is performed through the multi-use instant cooking kit to the purchase interface according to information on the ingredient pack, the seasoning pack, and the raw rice can selected from a user account; and
an ingredient selection guide unit for guiding selection of the ingredient pack, the seasoning pack, and a type of raw rice according to disease and health characteristics of a user, which are information stored in the user account.

15. An instant cooked food supply system using a shelf-stable multi-use instant cooking kit according to claim 6, the instant cooked food supply system comprising:
an interface provision unit for providing a purchase interface, which is for purchasing a container, an ingredient pack, a seasoning pack, and a raw rice can of the multi-use instant cooking kit independently or in a set, to a user terminal;
a cuisine result prediction information provision unit for providing information on a cuisine prepared when cooking is performed through the multi-use instant cooking kit to the purchase interface according to information on the ingredient pack, the seasoning pack, and the raw rice can selected from a user account; and
an ingredient selection guide unit for guiding selection of the ingredient pack, the seasoning pack, and a type of raw rice according to disease and health characteristics of a user, which are information stored in the user account.
